(19) United States
(12) Patent Application Publication
(10) Pub. No.: US 2014/0152608 A1
(43) Pub. Date: Jun. 5, 2014

(54) TOUCH PANEL

(71) Applicant: HENGHAO TECHNOLOGY CO. LTD, Taoyuan County (TW)

(72) Inventor: YEN-CHUN PENG, Taoyuan County (TW)

(73) Assignee: HENGHAO TECHNOLOGY CO. LTD, Taoyuan County (TW)

(21) Appl. No.: 13/725,293

(22) Filed: Dec. 21, 2012

(30) Foreign Application Priority Data
Nov. 30, 2012 (TW) 101145027

(51) Int. Cl. G06F 3/044

(52) U.S. Cl. CPC G06F 3/044
USPC 345/174

(57) ABSTRACT

A touch panel includes a first sensing electrode layer formed on a first surface of a transparent substrate, the first sensing electrode layer having plural first electrodes. Plural first dummy electrodes are disposed among the first electrodes of the first sensing electrode layer respectively, and are electrically insulated from the first electrodes. A second sensing electrode layer is formed on a second surface being opposite to the first surface. The second sensing electrode layer includes plural second electrodes, which are disposed complementally in relation to the first electrodes.

### CROSS-REFERENCE TO RELATED APPLICATIONS

The entire contents of Taiwan Patent Application No. 101145027, filed on Nov. 30, 2012, from which this application claims priority, are incorporated herein by reference.

### BACKGROUND OF THE INVENTION

1. Field of the Invention

The present invention generally relates to a touch panel, and more particularly to a touch panel with dummy electrodes.

2. Description of Related Art

A touch screen is an input/output device that adopts sensing technology and display technology, and has been widely employed in electronic devices such as portable or hand-held electronic devices.

A capacitor-based touch panel is a commonly used touch panel that utilizes capacitive coupling effect to detect touch positions. Specifically, capacitance corresponding to a touch position changes and is thus detected, when a finger touches a surface of the touch panel.

A conventional touch panel includes vertical electrode lines and horizontal electrode lines. Gap need be reserved for preventing electrically shoring between the vertical electrode lines and the horizontal electrode lines. Accordingly, trace phenomenon occurs when users look at the touch panel.

Moreover, base capacitance occurs between the vertical electrode lines and the horizontal electrode lines. The base capacitance lowers overall effective touch capacitance, and thus reduces touch sensitivity. One method to reduce the base capacitance in order to raise overall effective touch capacitance is to increase thickness of a transparent insulating layer between the vertical electrode lines and the horizontal electrode lines. The thicker transparent insulating layer, however, worsens the trace phenomenon.

For the reasons that the conventional touch panel possesses visual trace and base capacitance that should be compromised, a need has thus arisen to propose a novel touch panel to overcome disadvantages of the conventional touch panel.

### SUMMARY OF THE INVENTION

In view of the foregoing, it is an object of the embodiment of the present invention to provide a touch panel with dummy electrodes for greatly minimizing visual trace phenomenon such that a thicker transparent substrate can be used between two electrode layers. Therefore overall effective touch capacitance can be raised without worsening the visual trace phenomenon.

According to one embodiment, a touch panel includes a transparent substrate, a first sensing electrode layer, a plurality of first dummy electrodes and a second sensing electrode layer. The first sensing electrode layer is formed on a first surface of the transparent substrate, and the first sensing electrode layer has a plurality of first electrodes. The first dummy electrodes are disposed among the first electrodes of the first sensing electrode layer respectively, and are electrically insulated from the first electrodes. The second sensing electrode layer is formed on a second surface of the transparent substrate, wherein the second surface is opposite to the first surface. The second sensing electrode layer includes a plurality of second electrodes that are disposed complementally in relation to the first electrodes.

### BRIEF DESCRIPTION OF THE DRAWINGS

FIG. 1A shows a top view of a touch panel according to a first embodiment of the present invention;

FIG. 1B shows a cross-sectional view along a section line 1B-1B′ of FIG. 1A;

FIG. 2 shows a partial enlarged top view of the touch panel of FIG. 1A;

FIG. 3 shows a cross-sectional view of a touch panel according to a second embodiment of the present invention; and

FIG. 4 shows a cross-sectional view of a touch panel according to a third embodiment of the present invention.

### DETAILED DESCRIPTION OF THE INVENTION

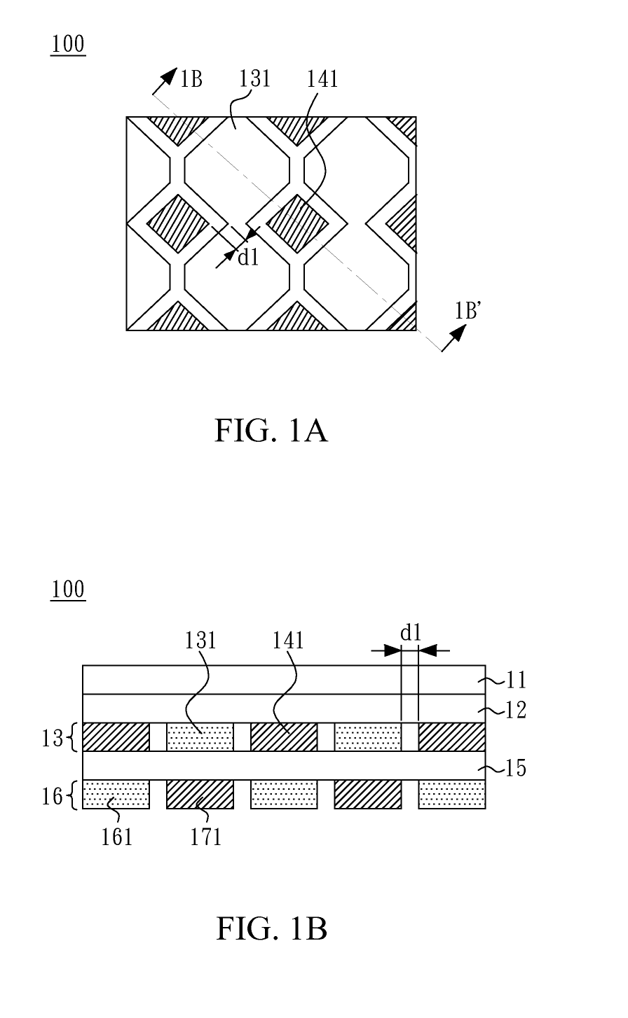

FIG. IA shows a top view of a touch panel 100 according to a first embodiment of the present invention, and FIG. 1B shows a cross-sectional view along a section line 1B-1B′ of FIG. 1A. Although rhombic electrodes are demonstrated in the embodiment, electrodes of other shapes may be used instead. In the specification, a direction “top” points to a touch surface of the touch panel, and a direction “bottom” points to a direction opposite the touch surface.

In the embodiment, the touch panel 100 includes a transparent cover layer 11, which may be composed of one or more sub-layers. The transparent cover layer 11 may be made of a flexible or hard insulating material, such as glass, polycarbonate (PC), polyethylene terephthalate (PET), polymethyl methacrylate (PMMA) or cyclic olefin copolymer (COC). The use of the flexible material may result in a flexible touch panel. The transparent cover layer 11 may possess protection function, and may further possess anti-wear, anti-scratch, anti-reflection and/or anti-fingerprint function by processing or addition to its top surface.

The touch panel 100 also includes a first sensing electrode layer 13 attached to the transparent cover layer 11 via an adhesive layer 12. The adhesive layer 12 includes an insulating material such as transparent photosensitive material, polymer or optically-clear adhesive (OCA). The first sensing electrode layer 13 may include adhesive such that the adhesive layer 12 is no longer needed. and may thus be omitted. In the embodiment, the first sensing electrode layer 13 includes a plurality of first electrodes 131, which are connected in series to form a plurality of parallel first electrode lines as shown in FIG. 1A.

The first sensing electrode layer 13 of the embodiment may be a light-transmissive structure made of a non-transparent material. In one embodiment, the first sensing electrode layer 13 includes metal nanowires (e.g., silver nanowires or copper nanowires) or metal nanonets (e.g., silver nanonets or copper nanonets). The metal nanowires or nanonets have a diameter in a nanometer order (i.e., a few nanometers to hundreds nanometers), and may be fixed in the first sensing electrode layer 13 via a plastic material (e.g., resin). Due to fineness of the metal nanowires/nanonets unobservable to human eyes, the first sensing electrode layer 13 made of the metal nanowires/nanonets thus has high light-transmittancy. In another embodiment, the first sensing electrode layer 13 may also include a photosensitive material (e.g., acrylic), through which electrodes with a required pattern may be formed via an exposure development process.

According to one aspect of the embodiment, the touch panel 100 may also include a plurality of first dummy electrodes 141, which are disposed among the first electrodes 131 of the first sensing electrode layer 13, respectively. As shown in FIG. 1A and FIG. 1B, the first dummy electrodes 141 and the first electrodes 131 are disposed in the same layer, and the first dummy electrodes 141 and the first electrodes 131 are electrically insulated. from each other. The first dummy electrodes 141 of the embodiment may be made of an insulating or conductive material such as, but not limited to, photosensitive material or polymer. In the embodiment, a distance d1 between the first dummy electrode 141 and a neighboring first electrode 131 may be less than or equal to 40 nanometers. Accordingly, the visual trace phenomenon may thus be greatly reduced when users look at the touch panel 100.

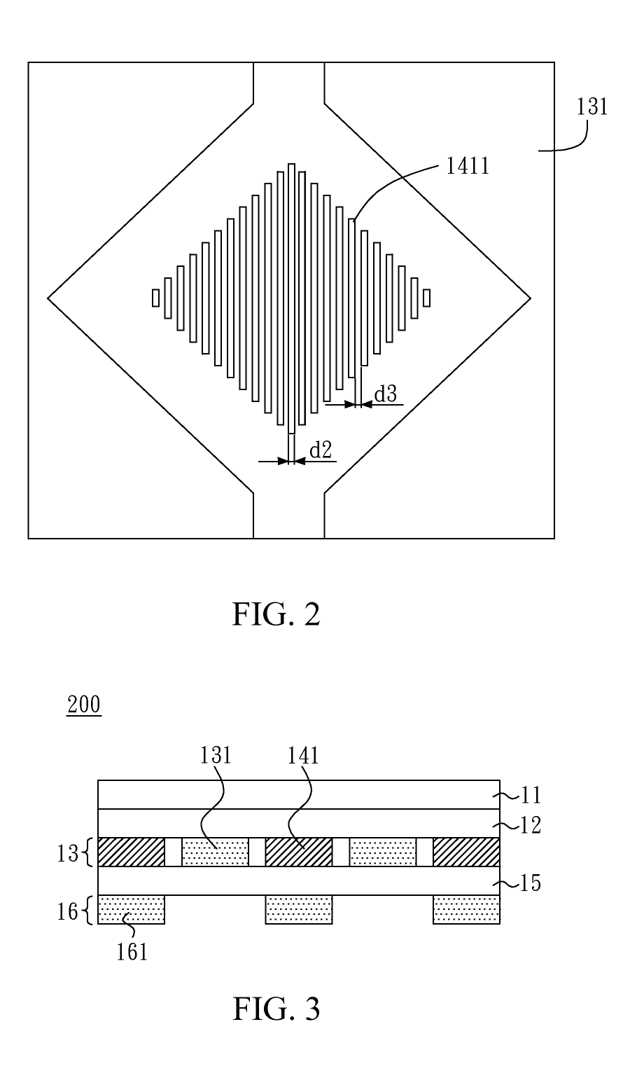

According to one embodiment, the first dummy electrode 141 may have a specific pattern as exemplified in an enlarged partial top view of FIG. 2. As shown in the figure, each first dummy electrode 141 is patterned to result in a plurality of strips 1411. In a preferred embodiment, a width d2 of the strip 1411 may be less than or equal to 90 nanometers, or between 10 and 90 nanometers, or preferably about 50 nanometers. Accordingly, capacitive coupling effect may be lowered to enhance driving capability of the touch panel 100. Further, distance d3 between the strips 1411. may be less than or equal to 40 nanometers, or between 10 and 40 nanometers, or preferably about 30 nanometers. Accordingly, visual trace phenomenon may be further reduced.

Referring back to FIG. 1A/1B, the touch panel 100 may also include a second sensing electrode layer 16, and a transparent substrate 15 is disposed between the first sensing electrode layer 13 and the second sensing electrode layer 16. The second sensing electrode layer 16 of the embodiment may have a structure similar to the first sensing electrode layer 13 as discussed above. That is, the second sensing electrode layer 16 may include a plurality of second electrodes 161 as shown in FIG. 1B, which are connected in series to form a plurality of parallel second. electrode lines. The first electrodes 131 are disposed complementally in relation to the second electrodes 161. Further, a plurality of second dummy electrodes 171 are disposed among the second electrodes 131, respectively. As shown in FIG. 1B, the second dummy electrodes 171 and the second electrodes 161 are disposed in the same layer, and the second dummy electrodes 171 and the second electrodes 161 are electrically insulated from each other. The second dummy electrodes 171 of the embodiment may include a material similar to the first dummy electrodes 131. Further, the second dummy electrodes 171 may have a pattern similar to the first dummy electrodes 131, and their details are omitted for brevity.

The transparent substrate 15 mentioned above may be made of an insulating material such as glass, photosensitive material or polyethylene terephthalate (PET). The transparent substrate 15 should have a proper thickness, for example, greater than 50 nanometers, in order to lower the base capacitance between the first sensing electrode layer 13 and the second sensing electrode layer 16, therefore raising overall effective touch capacitance and enhancing the touch sensitivity. A thicker transparent substrate 15, however, incurs apparent visual trace phenomenon. The first dummy electrodes 131 and the second dummy electrodes 171 adopted in the embodiment may greatly reduce the visual trace phenomenon. Although both the first dummy electrodes 131 and the second dummy electrodes 171 are used in the embodiment shown in FIG. 1B, either the first dummy electrodes 131 or the second dummy electrodes 171, however, may be omitted in other embodiments. For example, in some embodiments, only the first dummy electrodes 131 of the first sensing electrode layer 13 are used.

With respect to the touch panel 100 shown in FIG. 1B, if the transparent cover layer 11 is made of glass, the resulting structure may be called a one-glass-solution (OGS) touch panel. An additional glass layer (not shown) may be selectively formed on a bottom of the second sensing electrode layer 16 to result in a two-glass-type touch panel.

FIG. 3 shows a cross-sectional view of a touch panel 200 according to a second embodiment of the present invention. The present embodiment is similar to the first embodiment (FIG. 1B), with the exception that the second sensing electrode layer 16 of the present embodiment is made of a transparent conductive material such as indium tin oxide (ITO) or indium zinc oxide (IZO). In the embodiment, no dummy electrodes are required among the second electrodes 161 of the second sensing electrode layer 16 for reducing the visual trace phenomenon.

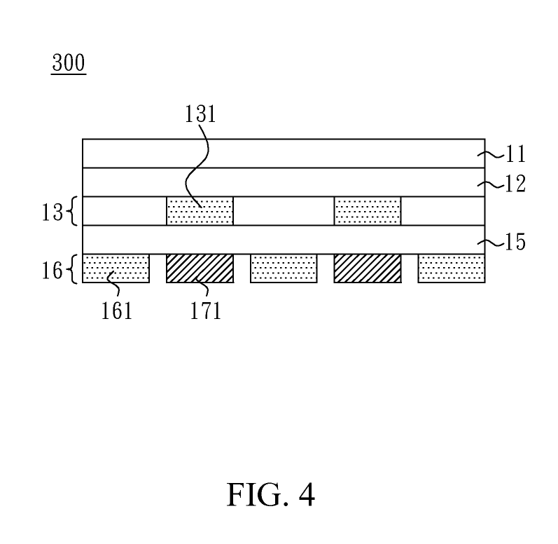

FIG. 4 shows a cross-sectional view of a touch panel 300 according to a third embodiment of the present invention. The present embodiment is similar to the first embodiment (FIG. 1B), with the exception that the first sensing electrode layer 13 of the present embodiment is made of a transparent conductive material such as indium tin oxide (ITO) or indium zinc oxide (IZO). In the embodiment, no dummy electrodes are required among the first electrodes 131 of the first sensing electrode layer 13 for reducing the visual trace phenomenon.

Although specific embodiments have been illustrated and described, it will be appreciated by those skilled in the art that various modifications may be made without departing from the scope of the present invention, which is intended to be limited solely by the appended claims.

What is claimed is:

1. A touch panel, comprising:
a transparent substrate;
a first sensing electrode layer formed on a first surface of the transparent substrate, the first sensing electrode layer having a plurality of first electrodes;
a plurality of first dummy electrodes disposed among the first electrodes of the first sensing electrode layer respectively, and electrically insulated from the first electrodes; and
a second sensing electrode layer formed on a second surface of the transparent substrate, the second surface being opposite to the first surface, the second sensing electrode layer including a plurality of second electrodes that are disposed complementally in relation to the first electrodes.

2. The touch panel of claim 1, wherein the first electrodes comprise a light-transmissive structure made of a non-transparent material.

3. The touch panel of claim 2, wherein the first electrodes comprise a plurality of metal nanowires or metal nanonets.

4. The touch panel of claim 3, wherein the first electrodes further comprise plastic material for fixing the metal nanowires or the metal nanonets in the first sensing electrode layer.

5. The touch panel of claim 3, wherein the first electrodes further comprise photosensitive material.

6. The touch panel of claim 1, wherein a distance between the first dummy electrode and a neighboring first electrode is less than or equal to 40 nanometers.

7. The touch panel of claim 1, wherein the first dummy electrode comprises a plurality of strips.

8. The touch panel of claim 7, wherein the strip has a width of less than or equal to 90 nanometers.

9. The touch panel of claim 7, wherein a distance between neighboring strips is less than or equal to 40 nanometers.

10. The touch panel of claim 1, further comprising a plurality of second dummy electrodes disposed among the second electrodes of the second sensing electrode layer respectively, and electrically insulated from the second electrodes.

11. The touch panel of claim 1, wherein the transparent substrate has a thickness greater than 50 nanometers.

12. The touch panel of claim 1, wherein the transparent substrate comprises glass, photosensitive material or polyethylene terephthalate (PET).

13. The touch panel of claim 1, wherein the second electrodes comprise transparent conductive material.
